(19) United States
(12) Patent Application Publication
(10) Pub. No.: US 2003/0039362 A1
(43) Pub. Date: Feb. 27, 2003

(54) Methods for indexing and storing genetic data

(76) Inventors: Andrea Califano, New York, NY (US); Aris Floratos, Astoria, NY (US); David Wang, Killdeere, IL (US); Peter Young, New York, NY (US)

Correspondence Address: ROPES & GRAY, ONE INTERNATIONAL PLACE, BOSTON, MA, 02110-2624, US

(21) Appl. No.: 09/939,200

(22) Filed: Aug. 24, 2001

(51) Int. Cl. H04L 9/00

(52) U.S. Cl. 380/283; 705/51

(57) ABSTRACT

Methods for indexing and storing genetic data include assigning a virtual private identity (VPI) to participants in a clinical study. The VPI may comprise a random number, or some other type of identifier that lacks any information that may be employed, in and of itself, to determine identity information. The system may then create an encrypted and secure database that contains the pairing between patient identity information and the assigned VPI. Information collected from the patient may be stored into data tables of a database where the VPI is employed as an index into the tables that store the patient data. The data stored in association with a respective VPI may be encrypted with an encryption key generated from the VPI. The encryption key may be stored in a Key Table and the Key Table may be encrypted with a Master Key.

### FIELD OF THE INVENTION

The invention relates to encryption of data, and more particularly to an encryption scheme for increasing the security of a database where private information is stored that is associated with an individual user identified by a User ID. More particularly, the systems and methods described herein include systems designed to support the creation, management, analysis, and archival of data produced from genetic studies and relative data. These include clinical and pharmacogenetic studies, post-marketing drug surveillance studies, and national genotyping projects.

### BACKGROUND OF THE INVENTION

The sequencing of the human genome will generate an avalanche of genetic information to be linked with information about microbial, chemical, and physical exposures; nutrition, metabolism, lifestyle behaviors, and medications. Interestingly, much like blood type information is today, this genetic information will likely be available to individuals as part of their medical profile. This information will be important as advances in DNA sequencing technology and in the understanding of the human genome will usher in a new era of genomic medicine, one with dramatic potential to not only benefit society through research involving human subjects, but also to cause economic or psychosocial harms to clinical subjects and their families. While in some cases such information may be beneficial to research subjects and their families, there is also the potential for misappropriation and misuse.

In today's medical environment a health practitioner or clinical trial sponsor would never consider sharing genetic data collected from a patient without the explicit consent of the participant. In most cases, particularly clinical studies, permission will not be given, and certainly, even if permission is given to share the genetic information, such permission is very likely to prohibit linking the disclosed genetic information with the actual identity of the participant that provided that genetic data. In these cases, the health practitioner is obligated to keep the patient's genetic and other data as private and protected as possible. This is not only important from a risk management perspective, but is basic to the proper practice of medicine.

Special concerns have arisen about the process for storing genetic information and other private data. Concerns have also arisen about how best to separate a participant's identity from the client's medical data. Current guidance and protections need to be enhanced to deal with the special considerations related to genetics research.

Thus, with the rapid advances in the computerization of medical data, including genetic data, the awareness of a need for protecting the privacy of medical records has begun to rise. Storing a large amount of sensitive information at a central location could open the door to “invasion of privacy” issues that were not as common as with the keeping of paper files.

Methods that address these issues and develop guidelines and frameworks for ensuring the safe and appropriate use of genetic information and other physical or biochemical traits are crucial to the success of large use of genetic and medical information.

Any system that stores and manipulates genotype, phenotype and other sensitive information must engender a sense of privacy and strong, but not obtrusive security. All classes of users must feel that while the application is easy to access and utilize, it will prevent any unauthorized individual, including highly experienced hackers, from accessing and manipulating any private information.

These principles are the prerequisites for the creation of highly secure, reliable, and centralized genetic system for the enrollment of large number of genetic study participants and for the storage, management, and analysis of their tissue samples, general type, medical and personal data. These principles must also apply to the creation of an online infrastructure to support an informed consent process that is dynamic in nature. That is, one that allows participants in a genetic study to be recontacted for follow-up studies without violating their privacy. Also, the system is expected to protect confidential genetic, medical, and personal data appropriately and diligently. The security mechanisms implemented within the application must earn the “trust” of all constituencies. These users must not have any doubt that their interactions with the application are private and confidential.

It would therefore be desirable to provide a system and a method that supports adequate security precautions to prevent people without appropriate authorization from accessing the information contained in its databases. Moreover, the most important privacy element, that is the association of individual identities with their corresponding genotype or phenotype data, must be inaccessible, or substantially inaccessible, to any authenticated user without the authorization of a supervisory trusted party.

### SUMMARY OF THE INVENTION

The invention is directed to systems and methods for securely storing genetic and medical data, as well as other types of private information. In one exemplary application the systems and methods described herein provide secure database systems that may be employed to protect confidential medical information of participants in a medical study. For example, in such a study a large number of participants may submit personal medical information for the study and this information is to be kept secret. To this end, the systems and methods described herein include embodiments and practices wherein study participants register with the study, and upon registration are assigned a virtual private identity (VPI). In one practice the VPI may comprise a random number, or some other type of identifier, that lacks any information that may be employed, in and of itself, to determine identity information, such as name or social security number of the participant assigned the respective VPI. The system may then create an encrypted and secure database that contains the pairing between patient identity information and the assigned VPI. For subsequent operations of storing or accessing patient data, the system may employ the VPI, thus, decoupling patient identity information from operations for reading and storing data. Once the patient has an assigned VPI, information collected from the patient may be stored into data tables of a database. In one practice the VPI is employed as an index into the tables that store the patient data. In particular, in one practice the VPI acts as an index key to identify a table, and optionally a row within that table, that stores information associated with that VPI.

The data, or portions of the data, stored in association with a respective VPI may optionally be encrypted with an encryption key. Optionally, this encryption key may be generated from the VPI according to a process or function, thus providing an encryption key, K_{VPI}, that is based on the VPI assigned to the respective patient. Depending upon the process or function employed, the generated encryption keys may be symmetric or asymmetric. In either case, an encryption key based on the VPI may provide a different key for each patient or participant.

The encryption key may be stored in a Key Table, typically a database table. Optionally, the Key Table may be encrypted with a Master Key, KM. A patient's encryption key is indexed from within the Key Table by the patient's VPI, similar to the manner by which the patient's medical data is stored in a table and indexed by the patient's VPI.

Thus, the VPI may act as the index for the patient's data and the key or keys employed for encrypting and decrypting that data. In optional practices, the VPI may also be encrypted, hashed or otherwise processed, to encrypt or secure the relational link for indexing the patient's data and the key or keys for encrypting and decrypting that information.

More specifically, the invention, in one embodiment, provides systems that protect the privacy of the many participants in a clinical study. To this end, the systems may be network based systems, including web-based systems, that support clinical studies that allow individuals to register with the clinical studies over a data network. The systems allow records for different individuals to be encrypted using different keys. Such systems also allow records for different patients to be accessed using a primary key, which is also encrypted using different keys. Furthermore, in this embodiment the keys employed to encrypt the individual records and primary keys are themselves encrypted using a Master Key and they are stored in a central Key Table indexed by a the primary key, which may be a unique random number, called the Virtual Private Identity (VPI).

In one aspect of the invention, one VPI is created for each participant in a study and is used as an index in two tables, a Key table and a Data Table. The Key Table is used to associate each of the VPIs created for the different participants with a preferably different encryption key K_{VPI}. All encryption keys K_{VPI} in the Key Table may be encrypted by a unique Master Key, K_{M}, that can be split for enhanced security. Optionally, the Key Table is located on a different computer system than the databases containing the Data Table(s). The encryption keys K_{VPI} stored in the Key Table are then used to encrypt all data or some predefined data in the Data Table. These keys can be either symmetric or they can be the private key of a public-private asymmetric pair where the public part is the VPI, or another key associated with the VPI. In the first case, data in the Data Table is both encrypted and decrypted using the same key K_{VPI}, while in the second case data is encrypted with the public portion of the key-pair and decrypted with the private portion of the key-pair. The systems described herein may employ the keys to decrypt data for allowing access to the data.

In one embodiment, the primary key (i.e., index) used to access the Data table is not the VPI but the encrypted version of the VPI, K_{VPI}(VPI). This guards against attempts to reconstruct the relational links between the individual data and the virtual private identity without knowing the master key.

It will be apparent to those of skill in the art from a review of the following examples, that a number of variants of this approach are possible where there are more than one key stored in the master table or where the primary keys of the data tables are a further mapping of the VPI or of the encrypted VPI, K_{VPI}(VPI). Furthermore, multiple levels of VPIs and or encrypted VPIs are possible.

Further features and advantages of the invention will be apparent from the following description of the following illustrated embodiments.

### BRIEF DESCRIPTION OF THE DRAWINGS

The following figures depict certain illustrative embodiments of the invention in which like reference numerals refer to like elements. These depicted embodiments are to be understood as illustrative of the invention and not as limiting in any way.

FIG. 1 shows schematically a secure data storage facility;

FIG. 2 shows schematically a system for encrypting data and storing the encrypted data on secure databases;

FIG. 3 depicts one example of key tables and data tables;

FIG. 4 depicts a further example of key tables and data tables suitable for use with the systems and methods described herein;

FIG. 5 depicts still another example of key tables and data tables suitable for use with the systems and methods described herein;

### DETAILED DESCRIPTION OF CERTAIN ILLUSTRATED EMBODIMENTS

The invention provides systems and methods that, inter alai, are directed to techniques for storing and managing confidential or private data generated from genetic studies, including, but not limited to, pharmacogenetic studies, post-marketing drug surveillance studies, and national genotyping projects. The systems and methods described herein operate for increasing the security of a database where such information, or any private information, is stored on an individual basis and where each individual is identified by a universal mechanism, such as a serial number or a User ID. In particular, the systems and methods described herein can be used to enhance the security for storing and manipulating medical records, financial data, military data, and any application where, among other issues, security on a per record level is advantageous. These systems and methods also allow for recontacting an individual that has stored information in the system. The purpose for recontacting the individual will vary according to the application, and may include contacting an individual about results achieved during a clinical study or about shareholder rights. Other applications and purposes will be apparent to those of skill in the art.

In one particular exemplary application, the systems and methods described herein provide for secure data storage for data generated or collected during a clinical study. For example, in certain applications, the systems and methods described herein may support a health care practitioner carrying out a clinical study wherein prospective study participants have provided genetic data, medical history, and other information. The health care practitioner may employ this information for screening the prospective participants to identify those that are to partake in the study. The health care professional may employ the systems and methods described herein to store a person's identity information, as well as the person's genetic data. To this end, the systems and methods of the invention may include database systems that separate the patient's identity information from the patient's medical data. The separated identity and medical data may then be securely stored within a database table, and done so in a way that allows the health care practitioner to store portions of the data in a secure format, typically as encrypted data. Other tuples of medical data may be stored in a non-secure format, typically in clear text, thereby providing data that the database management system may expose for searching the data and building views.

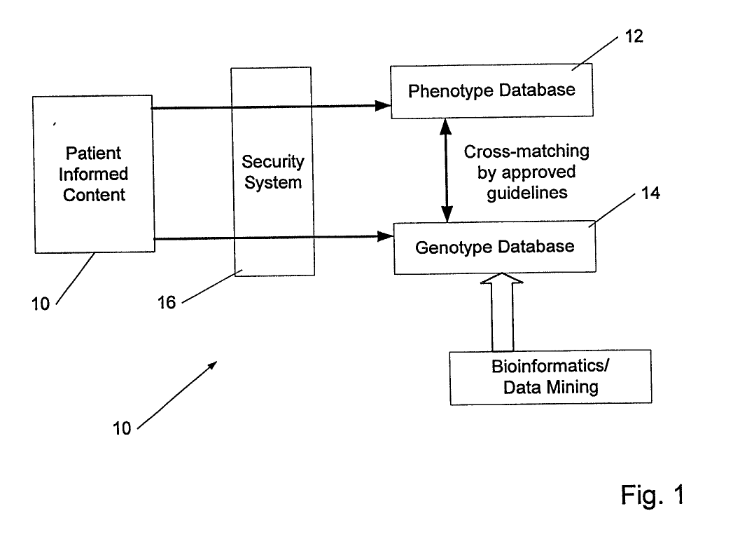

Referring first to FIG. 1, an exemplary system 10 is depicted that has a secure database 12, 14 that stores phenotype and genotype information, respectively, wherein the information can be cross-matched by approved guidelines which are outside the scope of the present application. The exemplary system allows a patient's medical data, i.e., “Patient Informed Content” 18, for study participants to be entered, for example, by an authorized physician. The type of data to follow and report are defined in a study protocol. The collection of all that data can constitute a “Study-Specific Medical Record” (SSMR) of the study participants. Optionally, a “Universal Medical Record Model” (UMRM) may be adapted to describe (possibly using XML DTDs) a large number of phenotypic traits stored on the phenotype database 12. For such traits, the UMRM will contain information like (i) the trait name (e.g., “blood pressure”), (ii) the associative value type (e.g., “numeric”), (iii) permissible ranges (e.g., “positive, less than 40”), etc. A security system 16 allows only authorized persons (e.g., the authorized physician or a proxy) that have appropriate rights to the study participant's account, to alter the SSMR of a study participant.

It will be understood, however, that such system is not limited to the aforedescribed application, but could also be used for other applications requiring a high level of data security.

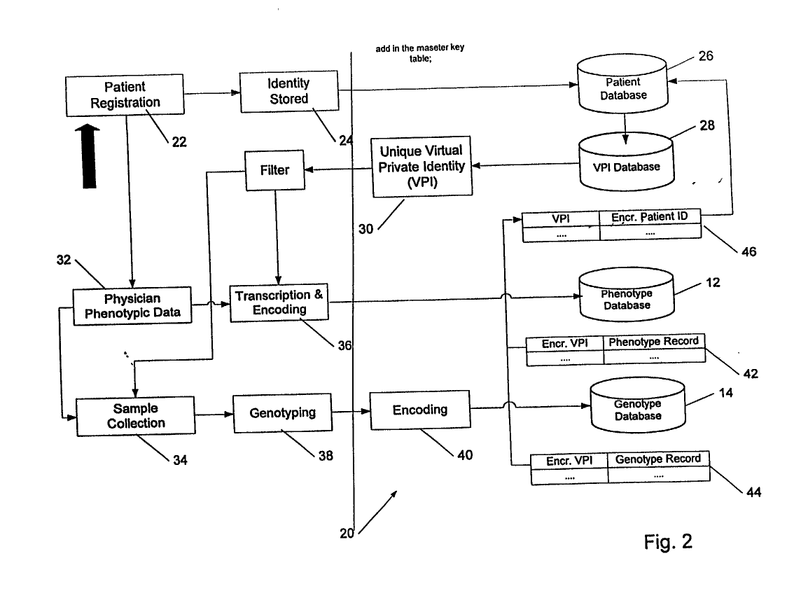

Referring now to FIG. 2, in a secure system 20, a patient registers with a physician to participate in a study, 22, and the patient's identity is stored, 24, in a patient database table 26. To protect the patient's identifiable information, a random number, called the Virtual Private Identity (VPI), is generated for the patient and stored in a VPI database 28 in a table that associates the stored VPI with an encrypted value of the Patient ID stored in the database 26. The encryption scheme described herein is independent on the access control method used by the database vendor as the Relational Database Management System (RDBMS) used. By way of example, the depicted databases can be any suitable database system, including the commercially available Microsoft Access database, and can be a local or distributed database system. The design and development of suitable database systems are described in the literature, including McGovern et al., A Guide to Sybase and SQL Server, Addison-Wesley (1993). The database can be supported by any suitable persistent data memory, such as a hard disk drive, RAID system, tape drive system, floppy diskette, or any other suitable system. The system depicted in FIG. 2 includes a database device that is separate from the data processing platform, however, it will be understood by those of ordinary skill in the art that in other embodiments the database device can be integrated into the data processing platform, including a web server system.

The patient's phenotypic data 32 entered by the physician and their association with the patient, in encrypted form, as will be described in detail below, are stored in the phenotype database table 12 indexed by the VPI of the patient. Likewise, genotypic data can be stored after sample collection 34 and genotyping the samples, 38, in encrypted form in the genotype database table 14, also indexed by the VPI of the patient. Furthermore, the identity information of the patient, e.g., name, SSN, etc., can be stored in an identity database table shown as 26 in FIG. 2 also in encrypted form and indexed by the encrypted value of the VPI rather than directly by the VPI. This later optional step reduces the ability to trace back the genotypic and phenotypic data of the individual starting from the table that contains the identity information even if the encryption key is known because the VPI is not stored in the identity table and cannot, or cannot feasibly, be reconstructed from its encrypted form.

As mentioned above, the phenotypic and genotypic data in the databases 12 and 14 are advantageously stored in the form of tables, with rows of the tables indexed by the encrypted VPI, while the identification information is stored in a table with rows of the table indexed by the encrypted VPI. The depicted system incorporates a separate and unique table with a list of the encryption keys K_{VPI} related to the VPI's. This table will be referred to hereinafter as the “Key Table.”

Each user related table is indexed on a primary key based on the VPI. This could be the VPI itself, a function, such as a hash function, of the VPI, or the encrypted VPI. The process employed for creating the hash of the VPI may include any suitable hash function, including any of the hash functions discussed and described in Bruce Schneier, Applied Crytpography (Addison-Wesley 1996), the contents of which are incorporated by reference. By way of example, the system may employ the MD5 hash process to create the hashed key for indexing data within the Key and Data Tables. Each row in a table indexed by the VPI will have all or some fields encrypted with the corresponding K_{VPI} key, uniquely associated to the VPI through the Key Table. Independent rows indexed by the same VPI will be partly or fully encrypted with the same encryption key. Consequently, anybody who breaks or otherwise decrypts any row indexed by a VPI, will be able to also read in clear text any other row in any related table for that same VPI, and for that VPI only. Other VPI indexed records will still be secure.

The Key Table contains a list of encryption keys related to the VPI's. To optimize data security of the system, the Key Table may be located on a different database, preferably on a different system, than the databases 26, 28, 12, and 14. For example, this list of encryption keys and VPI's can be located on a Lightweight Directory Access Protocol (LDAP).

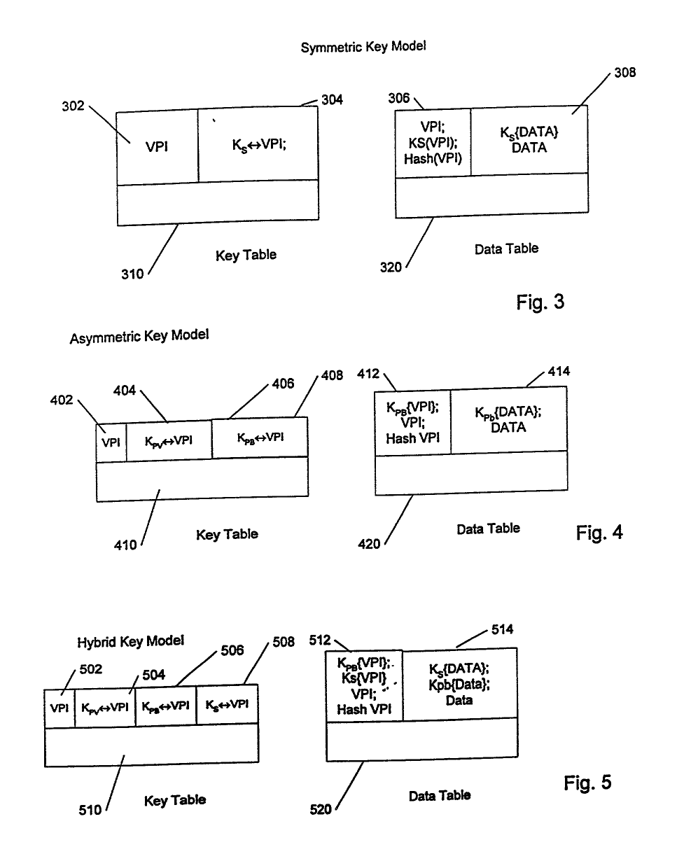

The security of the system can be further enhanced by encrypting the Key Table with a master key, referred to as “Mega-Key.” This can also be either symmetric or asymmetric in nature. Since the Key Table does not contain any easily identifiable information, but merely seemingly random numbers consisting of the VPIs and of the encryption keys K_{VPI}, as seen in FIGS. 3, 4, and 5, the Key Table will be difficult to break computationally. It is a further realization of the invention, that genetic data and financial numeric data presents information as a sequence of symbols, letters or other marks. This presentation is difficult to break computationally as it avoids or resists some of the more common attacks applied to encrypted data, including attacks, like word count attacks, that seek to identify portions of the encrypted text that appear to represent common words, such as the word “the”. Thus, in certain embodiments of the invention, the systems described herein include systems that segment that portion of the genetic data that may be presented as a string of marks into a separate tuple that may be encrypted separately. This may make the decryption of this information more difficult than if this information was encrypted in combination with common English words, or words of another language. Optionally, the Mega-Key K_{M} will be harder than the individual encryption keys K_{VPI}. For instance, the individual encryption keys could be 128-bit while the Mega-Key could be 1024-bit.

Referring now to FIGS. 3, 4 and 5, the association between the Key Table and the Data Table stored in databases 12, 14, respectively, can be implemented either using a symmetric key model (FIG. 3), an asymmetric key model (FIG. 4), or a hybrid key model (FIG. 5). With the symmetric model illustrated in FIG. 3, the primary key K_{VPI} that encrypts the data 308 in each user-related Data Table 320 may be generated independently for each VPI and is associated with the VPI in the Key Table. The VPI itself or the encrypted VPI, K_{VPI}(VPI), or a function of either one may be used as the primary key 302 for the Key Table 310.

The Key Table 310 contains the symmetric key K_{VPI} 304 generated and corresponding one-to-one to the VIP 302. With the symmetric key model, the data are accessed in the following manner: any user-related Data Table 320 is indexed by the VPI or by the encrypted VPI, K_{VPI}(VPI), or by a hash or other function of either. In order to get the encrypted data fields 308 corresponding to a VPI 306, the Key Table 310 is to be accessed. First, the row indexed by the VPI in the Key Table 310 is to be decrypted with the Mega-Key. As described above, the Mega-Key may be a symmetric key and it may have to be assembled from more than one part. Once the appropriate Key Table row is decrypted the symmetric key K_{VPI} 304 corresponding to the VPI 302 is obtained.

Once the appropriate user-related Data Table row 320 is identified based on the VPI or on the encrypted VPI, or on a function of either, the data may be decrypted using the symmetric key K_{VPI} 304 from the Key Table 310. Thus, during a study data may be selected from the data table 308. This data selection may be achieved using any suitable technique, and may for example include conventional database queries performed on the clear text within the data table 320. Thus, a clinician may search the database to identify all males within a certain age range and living in a specific geographic region. This search may be performed on clear text demographic data to identify individuals that meet these characteristics. For each individual, the system may provide the VPI, encrypted data and clear text data associated with the data record. Optionally, the clinician may send the VPI data to the administrator of the database system 10 with a request to contact the individuals to ask if they would be willing to participate in a clinical study. Additionally, the clinician may request the system administrator with a request to have the encrypted data, or portions of the encrypted data, decrypted for use in the study. As can be seen from this above example, the systems described herein provide for flexible control over the data stored in the data table 320, including the ability to contact the owner of the data and to allow controlled access to clear text and encrypted or secure data.

Thus, FIG. 3 depicts one embodiment of the systems described herein wherein a symmetric key is employed for encrypting and decrypting data associated with a user. FIG. 4 illustrates an alternative embodiment, wherein an asymmetric key is employed for encrypting and decrypting data associated with a user. Specifically, FIG. 4 illustrates a Key Table 410 that stores the VPI 402, a private portion of the key, Kₚᵥ and the Public portion of the Key K_{pb}. FIG. 4 further depicts a data table 420 that stores data associated with the user. As shown, the data, 414, may be encrypted, in part or in whole, and stored within the data table 420. FIG. 4 illustrates that the data that is encrypted may be encrypted with the public Key 408 of the Key Table 408. The Data Table 420 may also store the VPI, the encrypted VPI, a hash of the VPI or some other function thereof, to provide an index key for accessing the data 414. In this asymmetric model, the K_{VPI} may be the private part of the public and private key pair, and the VPI, or a function of the VPI, may be the public part of the pair. Thus, the system described herein may employ a public key encryption process to store data in an encrypted format within the data table 420. Public Key encryption processes are known in the art and described in the literature, including in Bruce Schneier, Applied Crytpography (Addison-Wesley 1996), the contents of which are incorporated by reference. This asymmetric embodiment may be used to securely encrypt data remotely for each individual patient without having to divulge the private encryption key. That is, data is encrypted, say by a physician, using the VPI and can be then decrypted by the system using the K_{VPI}. Thus, the public key may be employed for encryption and the private key may be employed for decryption.

The practices depicted in FIGS. 3 and 4 may be joined into a hybrid system, such as the system depicted in FIG. 5. Specifically, FIG. 5 depicts a hybrid system that employs both a symmetric key and the public and private key of FIG. 4. As shown in FIG. 5, the hybrid key model includes a key table for keeping the keys. The Key table 510 includes the VPI 502, the private key 504, the public key 506 and the symmetric key 508. The Key Table may work with the Data Table 520 that included the index keys 512, shown as the public, private, hash or some other function, of the VPI. The data may be encrypted with the symmetric key, the public key or left in the clear. Thus the hybrid model provides alternate levels of security for the data stored in the system,

The symmetric key model is simpler and may be applied in a majority of cases. The asymmetric key model is more complex and may be suitable for special, high security cases where data must be encrypted securely by a third party outside of the system. The Key Table format for the asymmetric model is identical to the format for the symmetric model, so one format for the Key Table is advisable. The symmetric and asymmetric key models will have to be differentiated before the Data Tables are accessed.

Accordingly, although FIG. 1 graphically as functional block elements, it will be apparent to one of ordinary skill in the art that these elements can be realized as computer programs or portions of computer programs that are capable of running on a data processor platform to thereby configure the data processor as a system according to the invention. As discussed above, the systems can be realized as a software component operating on a conventional data processing system such as a Unix workstation. In that embodiment, the system may be implemented as a C language computer program, or a computer program written in any high level language including C++, Fortran, Java or basic. General techniques for high level programming are known, and set forth in, for example, Stephen G. Kochan, Programming in C, Hayden Publishing (1983).

Those skilled in the art will know or be able to ascertain using no more than routine experimentation, many equivalents to the embodiments and practices described herein. Accordingly, it will be understood that the invention is not to be limited to the embodiments disclosed herein, but is to be understood from the following claims, which are to be interpreted as broadly as allowed under the law.

1. A system for securely storing medical data, comprising
an input process allowing an individual to enter identity information and medical data to associate with the identity information,
an encryption key process for providing to each individual an encryption key for encrypting medical data associated with the individual, and
a data table generator for storing medical data including encrypted medical data, in a table, whereby stored medical data from different individuals may be encrypted with different encryption keys.

2. A system according to claim 1, further comprising
a key table generator for storing the encryption key in a key table.

3. A system according to claim 1, wherein the input process includes
a private identity generator for generating for an individual a unique private identity being generated independently of the identity information.

4. A system according to claim 3, wherein the private identity generator includes a random number generator for generating a random number for the private identity.

5. A system according to claim 3, wherein the random number generator is selected from the group consisting of

6. A system according to claim 3, further including
means for employing the private identity as a relational link key for relating medical data associated with the individual to the encryption key associated with the individual.

7. A system according to claim 3, wherein the encryption key process includes a process for generating the encryption key as a function of the private identity.

8. A system according to claim 3 wherein the encryption key process includes a process for generating the encryption key as an asymmetric function of the private identity.

9. A system according to claim 3 wherein the encryption key process includes a process for generating the encryption key as a symmetric function of the private identity.

10. A system according to claim 2, further including
a table encryption process for encrypting the key table to secure the encryption key stored therein.

11. A system according to claim 3, further comprising
a relational link generator for processing the private identity to generate a relational link for associating medical data in the data table with a respective private identity.

12. A system according to claim 11, wherein the relational link generator includes a process for processing the private identity selected from the group consisting of a symmetric key algorithm, an asymmetric key algorithm, an asymmetric key algorithm, and a hash algorithm.

13. A system for storing medical data, comprising
an input process for allowing an individual to enter identity information and medical data to associate with the identity information,
a private identity generator for generating independent of the identity information,
a unique private identity for the individual,
an encryption key process for providing to the individual a respective encryption key for encrypting the medical data of the individual,
a relational link generator for providing relational links for the medical data and the encryption key associated with the individual, whereby the medical data and encryption key can be stored in a table of a relational database.

14. A system according to claim 13, wherein the relational link generator includes an encryption process for encrypting a relational link for accessing medical and/or the encryption key.

15. A system according to claim 13, wherein the relational link generator includes a hash process for generating a relational link as a hash function of the private identity.

16. A system according to claim 13, wherein the private identity generator includes a random number generator for generating the private identity as a function of a random number.

17. A system according to claim 16, wherein the relational link generator includes a process for encrypting the private identity to provide an encrypted relational link.

18. A process for controlling access to medical data, comprising:
allowing an individual to provide medical data and identity information,
providing the individual with a private identity and storing the medical data and identity information in tables of a relational database employing the private identity to provide a relational link to the medical and identity data,
employing the private identity to create an encryption key for the respective individual, and
encrypting, as a function of the encrypting key, medical data associated with the individual, whereby medical data of different individuals are encrypted with different respective encryption keys.

19. A process according to claim 18, further comprising:
allowing a medical professional to search the relational database to identify medical data of interest.

20. A process according to claim 18, further comprising:
allowing a medical professional to request identity information associated with medical data in the relational data base, and employing the private identity to notify the respective individual of the request.

21. A process according to claim 18, further comprising:
allowing the individual to control access to the medical data of the individual.

22. A process according to claim 18, further comprising:
allowing the individual to store portions of the medical data in the clear and portions in an encrypted form.

23. A process according to claim 22, comprising:
allowing a medical profess ional t o search the relational database.
